(19) United States
(12) Patent Application Publication
(10) Pub. No.: US 2007/0001522 A1
(43) Pub. Date: Jan. 4, 2007

(54) Vibration-damping receiving element

(76) Inventor: Hartmut Nitzsche, Buehl (DE)

Correspondence Address: KENYON & KENYON LLP, ONE BROADWAY, NEW YORK, NY, 10004, US

(21) Appl. No.: 10/573,618

(22) PCT Filed: Jul. 28, 2004
(86) PCT No.: PCT/DE04/01694

§ 371 Date: Mar. 27, 2006

(30) Foreign Application Priority Data
Sep. 25, 2003 (DE) 103-44-624.9

(51) Int. Cl. H02K 5/24; F16M 9/00

(52) U.S. Cl. 310/51; 248/638

(57) ABSTRACT

The present invention relates to a device for the elastic, vibration-damping accommodation of an assembly with respect to a mounting fixed to a frame, having at least one elastic element that is situated between the assembly and the mounting that is fixed to the frame, the assembly having at least one first support surface, and the mounting having at least one second support surface, and the two support surfaces face each other and run transversely, especially at right angles, to the vibrational plane of the vibration and, as seen in the direction of vibration, the elastic element lies in an overlapping position to the support surfaces. It is provided that the two support surfaces have a lateral clearance from each other, and that the first elastic element bridges the clearance in the form of a first free bridge.

### FIELD OF THE INVENTION

The present invention relates to an elastic, vibration-damping mounting of an assembly with respect to a holding device that is fixed in the frame, having at least one elastic element.

### BACKGROUND INFORMATION

Elastic, vibration-damping mountings according to the definition of the species are known. Such a vibration-damping mounting is especially intended to dampen torsional vibrations. To do this, at least one elastic element is situated between a component of the assembly and a component of the mounting that is fixed to the frame. The elastic element is made of a yielding material, preferably an elastomer. Because of forces such as the ones that occur in vibrations, the elastic element is deformed mechanically, for instance, pressed together, and therewith takes up the energy of the vibration. Because of its restoring behavior, the elastic element takes up once more its original shape and size. This process will repeat, so that a part of the energy of the vibration is consumed, and the vibration is damped. Thus, the damping takes place based on the pressing together of the elastic element between the components of the assembly and the mounting that is fixed to the frame, in many cases the damping of the vibration not being sufficient.

### SUMMARY OF THE INVENTION

By contrast, the elastic vibration-damping mounting according to the present invention offers the advantage that, on the elastic element, a free bridge is formed by the positioning of the support surfaces on components of the assembly and the mounting fixed to the frame in a laterally offset position. In the related art, the elastic element is only pressed together by clamping, and is not able to expand beyond the boundaries of its original size. In the present invention, however, a free bridge is developed, which permits a shearing motion of the elastic element, transversely to the direction of the vibration. By a shearing motion we mean, in this instance, the superposition of a torsional motion and a bending motion, and not a shearing movement having the effect of shearing off material. This shearing motion results in the extension of the elastic element, also transversely to the direction of the vibration. Depending on the extent of the deflection, an extreme extension is possible, for example, while forming an S-shaped form of the free bridge, since there is enough space available. This space is present based on the “freedom” of the free bridge, that is, since it is not clamped in between components. When unloaded, the elastic element once more takes up its initial size, based on the restoring force. The magnitude of the restoring force comes about due to the elastic properties of the material of the elastic elements. Upon being unloaded, the elastic element contracts in the opposite direction to that in which it extended before. There is created a relatively large freedom of motion for the elastic element, which leads to corresponding movements of same. Compared to the related art, by the creation of a new possibility of motion in a direction transverse to the vibrational direction, namely, permitting the shearing movement of the elastic element, a very good damping is achieved. From this, there arises the advantage that the changes in length and volume changes that are achieved, which the elastic element goes through during the squeezing together and the extension in the present invention, is of a different kind than that in the related art. In the related art, only a pressing together of the elastic element is permitted, having short changes in length, conditioned by the distance apart of the support forces of the components. Consequently, the present invention achieves a softer, more effective damping. Independently of the embodiment of the damping mechanism and the clamping device per se, the structural embodiment of the mounting that is fixed to the frame, especially the space required in the motor vehicle for accommodating the assembly in the mounting that is fixed to the frame, is similar to the type of construction described in the related art. This is relevant, since the mounting that is fixed to the frame, for example, a blower flange in a motor vehicle, is not able to be made larger at will. Because of the boundary conditions on the space available in a limited way for the mounting that is fixed to the frame, up until the present, not many design attempts were able to be implemented for the improved damping of the accommodation of an assembly in a mounting fixed in the frame.

In a preferred embodiment of the present invention, the assembly has at least one additional third support surface that is situated at a lateral distance from the first support surface, as well as a lateral distance from the second support surface. This third support surface faces the second support surface, and runs transversely, particularly at right angles, to the plane of vibration. As seen in the direction of the plane of vibration of the vibration, the second support surface lies between the first and the third support surface. As seen in the direction of vibration, the first elastic element lies in an overlapping position with respect to the second support surface and the third support surface, and it bridges the lateral distance between the second support surface and the third support surface in the form of a second free bridge.

Compared to the arrangement described before, this has the advantage that two free bridges have been developed, and the elastic element is able to move into two free spaces. This is advantageous for the damping of the vibration.

The mounting fixed to the frame has two support surfaces, and the assembly has one support surface. The damping takes place in the same manner as that which was described in the previous paragraph.

In one additional preferred embodiment, the mounting fixed to the frame has a fifth support surface that faces the second support surface. The assembly has a sixth and a seventh support surface, which have a lateral clearance from each other, and face the fifth support surface, and, as seen in the direction of the vibration plane of the vibration, the fifth support surface lying between the sixth and the seventh support surface, and a second elastic element, as seen in the direction of the vibration, lies in the overlapping position to the fifth, sixth and seventh support surfaces. The second elastic element bridges the lateral clearance between the fifth and the sixth support surface in the form of a fourth free bridge, as well as the lateral clearance between the fifth and the seventh support surface in the form of a fifth free bridge. The damping of the vibrations of the assembly takes place, in the embodiment described here, over the same vibration period, that is, a first half-wave having to and fro motion, and a second half-wave having to and fro motion. In the embodiments described before, on the other hand, only one half-wave of the vibration is damped. In the exemplary embodiment now being examined, the first half-wave is damped by the first elastic element, and the second half-wave appertaining to this is damped by the second elastic element. The first half-wave is damped in the form of a shearing movement of the first elastic element, the first and second free bridge acting along with it. In this context, the extension of the first elastic element increasing to a maximum extension. In the return motion of the first half-wave, because of the restoring force, the first elastic element contracts again until it reaches its original initial length. There it remains essentially at rest. The second half-wave of the vibration is damped by the second elastic element, which extends in the opposite direction to the first elastic element. Here too, there is again a point of maximum extension, and when this is reached, the second elastic element contracts again until it reaches its initial length. This process of extending and contracting of both elastic elements repeats several times with decreasing maximum extension in each case, until the elastic elements remain in their initial position. The vibration present as a one-time pulse is damped. If the operation of the assembly leads to continuous created vibrations, the shearing movement of the elastic elements does not die away down to zero, but leads to a continual amplitude reduction in the vibrations.

It is advantageous if the widths of the support surfaces are in each case less, compared to the lateral clearance of two support surfaces, in order to optimize the damping by the free bridge. However, the bridge should not be so small that the respective support surface cuts into the elastic element, for, if the width of the support surfaces is too small, then the surface load of the respective support surface could possibly be too great, so that the soft material of the elastic element is damaged.

In one preferred exemplary embodiment, it is provided, for the embodiment of the first and/or second elastic element, that it is made up in each case of several elastic partial elements. Alternatively it is provided that the first elastic element is developed as a unit together with the second elastic element. This unit may be made up of several Parts fastened to one another, or it may be formed as a one-piece component. A preferred exemplary embodiment of this one-piece development of the first elastic element and the second elastic element is a rectangular ring.

In one preferred exemplary embodiment, the mounting fixed to the frame has pockets that have two opposed pocket side surfaces, the two pocket side surfaces forming the two support surfaces.

In another preferred exemplary embodiment it is provided that the support surfaces of the assembly are developed in an adapter that is detachably connected to the assembly. This has the advantage that an assembly, that does not have any support surfaces, is able to be furnished with support surfaces by the simple assignment of the adapter.

In a further preferred exemplary embodiment of the present invention, it is provided that, as far as the assembly is concerned, a driving assembly is involved, especially an electric motor. This is preferably a DC motor. In still another preferred embodiment of the present invention, it is provided that the assembly is a driven assembly, for instance, a fan ventilator.

In yet another exemplary embodiment of the present invention, it is provided that the assembly is a motor vehicle assembly, and the mounting fixed to the frame is, for instance, a fixing structure of the chassis of the motor vehicle.

The subject matter of the present invention is preferably used for the damping of torsional vibrations, that is, vibrations about the axis of rotation about the shaft of the assembly developed as a motor.

### BRIEF DESCRIPTION OF THE DRAWINGS

FIG. 1 shows a longitudinal section through a driving assembly, in this case a motor, which is situated in a mounting fixed in the frame.

FIG. 2 shows a cross section along line II-II of the assembly shown in FIG. 1.

FIG. 3 shows a schematic representation of a damping device between the assembly and the mounting fixed to the frame.

FIG. 4 shows a schematic representation of a further exemplary embodiment of a damping device between the assembly and the mounting fixed in the frame.

FIG. 5 shows a schematic representation of a further exemplary embodiment of a damping device between the assembly and the mounting fixed in the frame.

FIG. 6 shows a schematic representation of a further exemplary embodiment of a damping device between the assembly and the mounting fixed in the frame.

FIG. 7 shows a schematic representation of a further exemplary embodiment of a damping device between the assembly and the mounting fixed in the frame.

FIG. 8 shows a view in perspective of a damping element developed like a bonnet.

FIG. 9 shows an exemplary embodiment corresponding to FIG. 1, but having an adapter.

### DETAILED DESCRIPTION

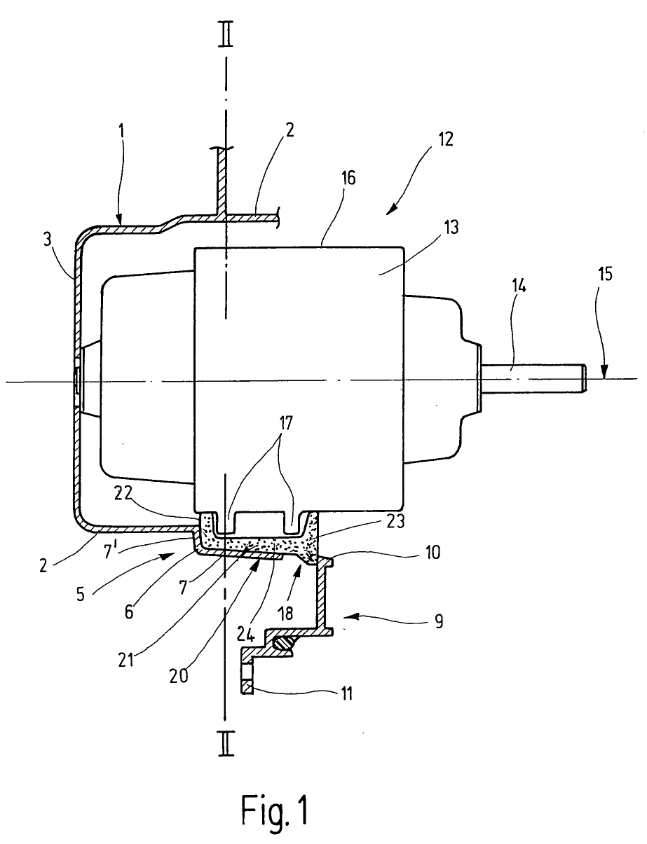

FIG. 1 shows a mounting 1 of a blower flange fixed to the frame. The blower flange is, for example, a blower flange of an air conditioning or heating system in a motor vehicle.

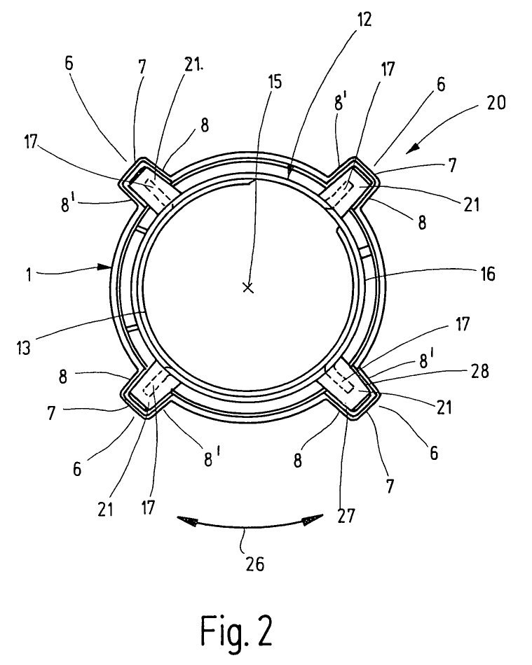

Mounting 1 fixed on the frame has a predominantly pot-shaped form, having a cylindrical sidewall 2 and a bottom 3. At side wall 2, a protuberance 5 is shown, which forms a pocket 6 that is described in more detail in FIG. 2. It has a pocket bottom 7 and a pocket end face 7′, as well as pocket side walls 8 and 8′ shown in FIG. 2. In this figure, only pocket bottom 7 and pocket end face 7′ are shown. In addition, mounting 1 that is fixed to the frame has a projection 9, whose constructive interplay with the pot-shaped part of mounting 1, that is fixed to the frame, is not shown in this figure. This projection 9 has a free end 10 facing side wall 2, and a free end 11 facing away from side wall 2.

In mounting 1 that is fixed to the frame, there is situated an assembly 19, in this case an electric motor 12, for instance a DC motor, having an essentially pipe-shaped stator frame 13. Electric motor 12 has a shaft 14.

Axis of rotation 15 of electric motor 12 runs through the shaft. At stator frame 13 of electric motor 12, at its circumference, holding tabs 17 are situated. Holding tabs 17 have an essentially rectangular side surface and, as a rule, are formed in one piece with stator frame 13. Furthermore, a device 20 is shown, which includes pocket 6 of mounting 1 that is fixed to the frame, holding tabs 17 and a damping element 21. Damping element 21 is developed in the shape of a bonnet, in this case, and has a first end face 22, a second end face 23 and a wall 24 that connects the latter two. Electric motor 12 is mounted in mounting 1 that is fixed to the frame, by being pushed along axis of rotation 15 into pot-shaped mounting 1 that is fixed to the frame, and, to be specific, so far until damping element 21 adjoins at its end wall 22 to pocket end face 7′ of pocket 6. Damping element 21 is fixed at second end face 23 by end 10 of projection 9, after it has engaged, because of its deformation made possible by its elastic material properties, in an opening 18 between end 10 of projection 9 and pocket 6.

In the following, the same parts are furnished with the same reference numerals, in order to avoid repetitions.

FIG. 2 shows a cross section along line II-II, of electric motor 12 shown in FIG. 1, and of mounting 1 that is fixed to the frame. Mounting 1 that is fixed to the frame has pockets 6, which are situated radially at circumference 16 of stator frame 13 of electric motor 12, in each case 90° apart from one another. Pocket 6 also has pocket side walls 8 and 8′, running perpendicular to the plane of the drawing. Damping element 21 is situated in pocket 6, a first side wall 27 of damping element 21 and a second side wall 28 of damping element 21 abutting pocket side walls 8 and 8′. End face 22 of damping element 21 being supported by pocket end face 7′. Holding tabs 17 extend into damping element 21.

Axis of rotation 15 runs into the plane of the drawing at the center of electric motor 12, and is shown as x. At circumference 16 of electric motor 12, four devices 20 may be seen, for accommodating electric motor 12 in mounting 1 that is fixed to the frame. A device 20 is designed in such a way that, between holding tabs 17 and pocket 6 of mounting 1 that is fixed to the frame, there is a damping element 21. Depending an the constructive design of electric motor 12, two diametrically opposite or even three devices 20 are possible, they being situated essentially at equal angular distances at the circumference. Alternatively, four devices 20 may also be situated at a distance of 90° from one another, as shown in this figure, or more devices 20, having in each case essentially the same angular distance from one another, at circumference 16 of electric motor 12.

In addition, it is also possible to situate devices 20 at circumference 16 of electric motor 12 in such a way that the angular spacing of devices 20 is irregular.

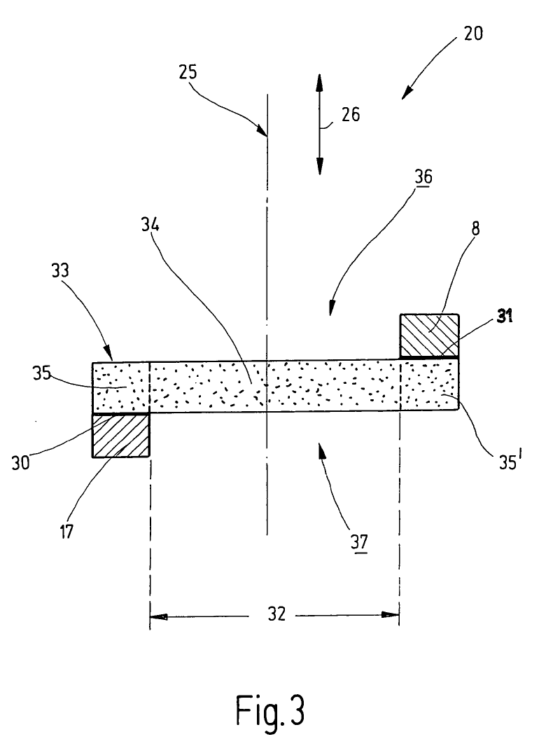

For example, in the operation of electric motor 12, because of cogging torque, rotary vibrations occur, vibrational direction 26 of the rotary vibration to be damped about axis 15 being shown as a double arrow. In order to reduce the transmission of rotary vibrations from electric motor 12 to mounting 1 that is fixed to the frame, accommodation device 20 is developed so that the rotary vibrations are damped by positioning the damping elements 21 between electric motor 12 and mounting 1 that is fixed to the frame. In FIGS. 3 to 7, exemplary embodiments of device 20 are shown schematically. In the light of these exemplary embodiments, there is shown also the operating mode of the rotary vibration-damping accommodation of an electric motor 12 in a mounting 1 that is fixed to the frame, using device 20.

FIG. 3 shows the simplest exemplary embodiment of device 20, for the rotary vibration-damping accommodation of an electric motor 12 in a mounting 1 that is fixed to the frame, in a schematic way. What is shown is a holding tab 17 having a first support surface 30. Pocket side wall 8 has a second support surface 31 on a projection. In the figure, the plane of vibration 25 of the rotary vibration is drawn in. The two support surfaces 30 and 31, as seen in vibrational direction 26, run at a lateral clearance 32 from each other. Between support surface 30 and support surface 31, as seen in vibrational direction 26, a first elastic element 33 is situated in overlapping fashion, and consequently it bridges the lateral clearance 32 of the two support surfaces 30 and 31 in the form of a first free bridge 34. First free bridge 34 is formed by the part of first elastic element 33 that lies between support surface 30 and support surface 31. The length of free bridge 34 corresponds to the lateral clearance of the two support surfaces 30 and 31. Overlapping areas 35 and 35′ of first elastic element 33 with support surfaces 30 and 31 are not a part of first free bridge 34. Above and below first free bridge 34, two free spaces 36 and 37 are developed, into which first elastic element 33 is able to move. By free space, a zone is understood in which there is no material present, be it material of elastic element 33 or material of mounting 1 that is fixed to the frame, or material of electric motor 12, or another material. Depending on the direction of the vibration in vibrational plane 25, first elastic element 33 will move into free space 36 or into free space 37. The function and effect of first free bridge 34 will be explained here in the light of a vibration which runs in vibrational plane 25 in such a way that support surface 30 applies a pulse from below to elastic element 33. First elastic element 33, because of its material properties, is able to be deflected upwards, and thereby to move into free space 36; in this context, it is submitted to a change in length. After its maximum deformation and extension, elastic element 33, on account of its restoring force, takes up its original position again, which is shown in FIG. 3. This procedure is repeated a few times at an amplitude of the deflection that becomes smaller, until there is no more motion of elastic element 33 into free space 36 to be recorded. The vibration of electric motor 12 has been damped, and therefore has not been transmitted to mounting 1 that is fixed to the frame.

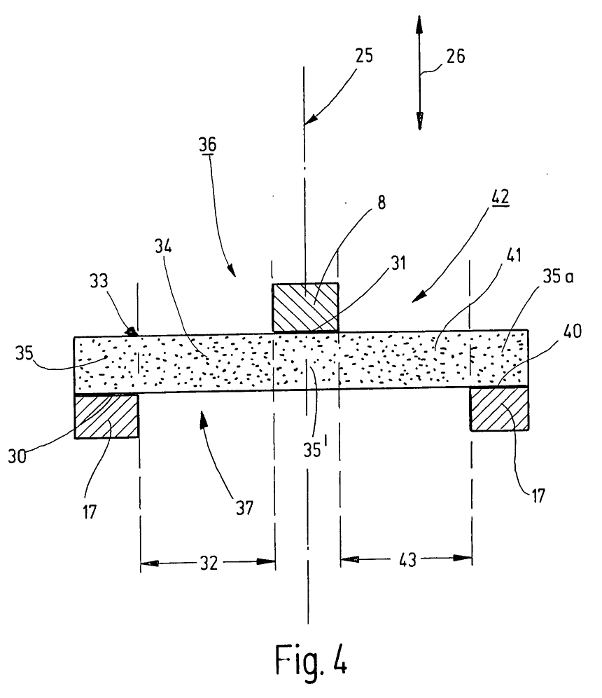

In FIG. 4, in a schematic representation, a further preferred exemplary embodiment of a device 20 is shown, in which two support surfaces 30 and 40 are developed at holding tabs 17, having a lateral clearance from each other, and a support surface 31 at a projection of pocket side wall B. Support surfaces 30 and 40 of holding tabs 17, of electric motor 12 that is not shown, and support surface 31 of pocket side wall 8 face one another, support surface 31, as seen perpendicular to vibrational plane 25, lying between support surfaces 30 and 40 of holding tabs 17. First elastic element 33 is situated in an overlapping manner between support surfaces 30 and 40 and support surface 31. It may be seen that, in addition to first free bridge 34 between support surface 31 and support surface 40, a second free bridge 41 is developed. An additional free space 42 is developed into which first elastic element 33 of second free bridge 41 is able to move.

Consequently, elastic element 33 is able to move into both free spaces 36 and 42. Lateral clearance 32 between support surface 30 and support surface 31 corresponds to the length of first free bridge 34, and lateral clearance 43 between support surface 40 and support surface 31 corresponds to the length of free bridge 41. As in FIG. 3, overlapping areas 35 and 35′ of first elastic element 33 with support elements 30 and 31 are shown, and in addition, an overlapping area 35a of first elastic element 33 with support area 40 is shown. If a vibration occurs in vibrational plane 25 in such a way that the two support surfaces 30 and 40 have an upward pulse applied to them, first elastic element 33 will move into free spaces 36 and 42. If the vibration occurs in the opposite direction, so that support surface 31 has applied to it a pulse resulting from the rotary vibration, first elastic element 31 moves into free space 37, with an extension in length. The advantage of this exemplary embodiment of the present invention is, thus, the formation of two free bridges, a better damping of the rotary vibration being effected.

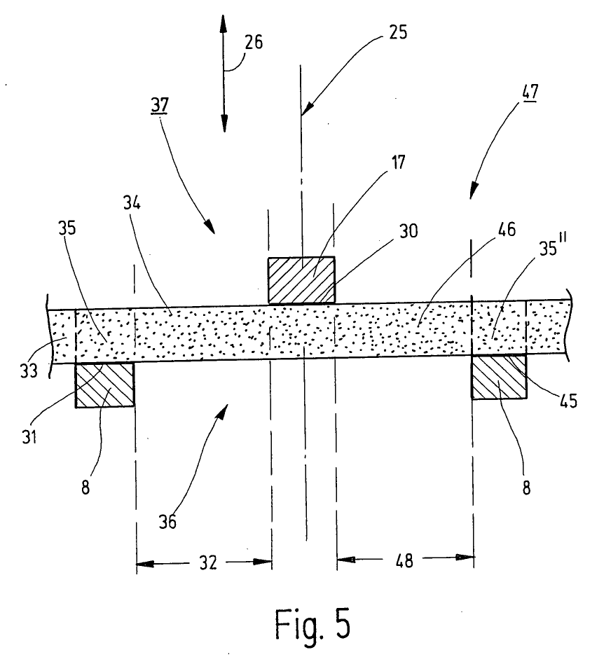

In a schematic representation, FIG. 5 shows an additional exemplary embodiment of the present invention, which make possible the same damping of a rotary vibration as in the exemplary embodiment shown in FIG. 4. Two support surfaces 31 and 45 are formed at projections of pocket side wall 8 of pocket 6, and one support surface 30 is formed at a holding tab 17. What is shown is support surface 31 and a support surface 45 of pocket side wall 8, which, as seen in vibration direction 26, faces support surface 30. Both support surfaces 31 and 45 are situated perpendicular to vibration plane 25 and having a lateral clearance from each other. First elastic element 33, as seen in vibration direction 25, is situated overlappingly between support surfaces 31 and 45 and support surface 30, First elastic element 33 being able to have a greater length than first element 33 shown in FIG. 4. In addition to free spaces 36 and 37 known from FIG. 3, an additional free space 47 is developed. In addition to first free bridge 34, an additional free bridge 46 is developed. In the exemplary embodiment described in this figure, first elastic element 33 may, consequently, move into free spaces 36, 37 and 47.

Lateral clearance 32 between support surface 30 and support surface 31 determines the length of free bridge 34, and lateral clearance 48 between support surface 30 and support surface 40 determines the length of free bridge 46. The overlapping area of elastic element 33 and with support surface 45 is designated by 35″. If a vibration in vibration plane 25 occurs in such a way that support surfaces 31 and 45 have applied to them a pulse of the rotary vibration that is directed upwards, first elastic element 33 moves with extension of its length into free spaces 37 and 47.

If the vibration occurs in the opposite direction, and support surface 30 of holding tab 17 has applied to it a pulse directed downwards, first elastic element 33 moves into free space 36.

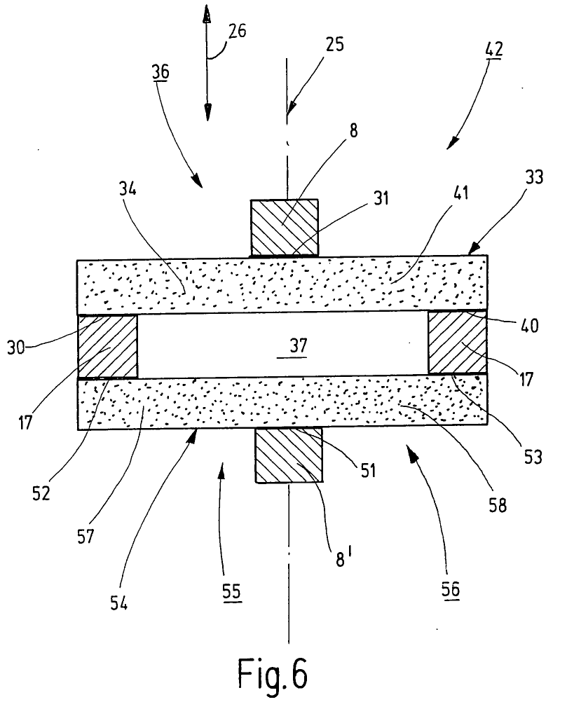

FIG. 6 shows an additional preferred exemplary embodiment of device 20 of the present invention, in a schematic representation. What is shown is pocket side wall 8, having support surface 31 provided at a projection, as well as opposite pocket side wall 8′having support surface 51 provided at a projection. Support surface 31 and support surface 51 face each other. Support surface 30 and support surface 40 face support surface 31, and a support surface 52 and a support surface 53 of holding tab 17 face support surface 51. Both support surfaces 52 and 53 are situated perpendicular to vibrational plane 25 at a lateral clearance from each other. First elastic element 33 is situated overlapping between support surface 31 and support surfaces 30 and 40. Second elastic element 54, as seen perpendicular to vibrational plane 25, is situated between support surfaces 51, 52 and 53 in an overlapping position. In the arrangement that is shown, in addition to free spaces 36, 37 and 42 known from the previous figures, free spaces 55 and 56 are developed. Because of the overlapping arrangement of elastic elements 33 and 54, in each case between support surfaces 31 and 51 and support surfaces 30, 40 and support surfaces 52, 53, free bridges 34, 41, 57 and 58 are developed. Whereas devices 20 shown in FIGS. 2, 3, 4 and 5 in each case damp only a half-wave of a vibration by elastic element 33, in device 20 shown here, both half-waves of a vibration are damped using the two elastic elements 33 and 54. If a vibration in vibrational plane 25 occurs in such a way that support surfaces 30, 40 have applied to them an upwards directed pulse introduced into holding tabs 17 in FIG. 6, first elastic element 33 is moved upwards against the restoring force of this element, in the area of support surfaces 30, 40. In this context, first elastic element 33 is supported on support surface 31, at the projection of pocket side wall 8. Also in this context, free bridges 34 and 41 are moved into free spaces 36 and 42.

First elastic element 33, in this context, in a moving-in motion, executes a maximum excursion and length extension, and, upon a subsequent return motion to the initial position, it executes the first half-wave of a vibration.

If holding tabs 17 are moved downwards beyond the initial position shown in FIG. 6, holding tabs 17 exercise a force, via support surfaces 52 and 53, on second elastic element 34, which is supported, in this context, on support surface 51 of pocket side wall 8′ that is provided at a projection. In such a movement, free bridges 57 and 58 shift into free spaces 55 and 56, whereby second elastic element 54 is bent downwards against its elastic restoring force and is submitted to a length extension. Second elastic element 54, in a moving-in motion, executes the second half-wave of a vibration up to the maximum excursion and length extension, and, in a subsequent return motion, into the initial position shown in FIG. 6. In an upward motion of holding tabs 17, first elastic element 33 is deflected and extended, and in an downward motion of holding tabs 17, correspondingly, second elastic element 54 is deflected downwards and submitted to a length extension. The elastic elements are in each case provided for the damping of a half-wave, specifically, while they are deflected and extended because of a relocation of holding tabs 17 during a rotary vibration. Because of the utilization of the damping properties of the two elastic elements 33 and 54, in each case one half-wave of the vibration is damped by one of the elements. All in all, thereby, the damping occurs in a softer manner.

In an advantageous manner, the dimensions, in this context, are selected in such a way that the length of the free space between holding tabs 17, which is bridged by elastic elements 33 or 54, is clearly greater than the length of support surfaces 31 or 51 on which elastic elements 33 or 54 are supported on the projection of pocket side walls 8 or 8′. In this way it is possible to damp rotary vibrations brought on by the motor in a better manner, since elastic elements 33 or 54 are movable in a tangential direction, because of the corresponding free space between holding tabs 17.

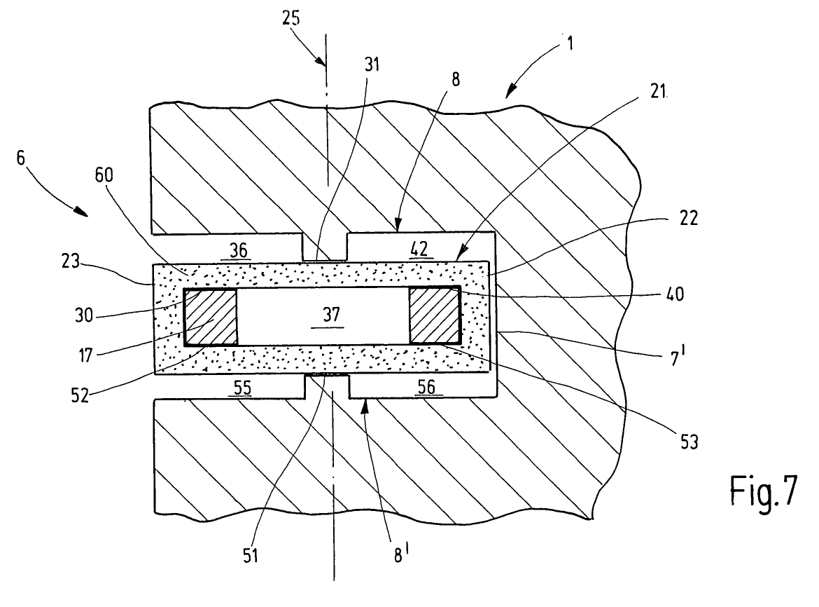

FIG. 7 shows schematically a further exemplary embodiment of the present invention. What is shown is pocket 6 of mounting 1 fixed to the frame, together with pocket side walls 8 and 8′. As is also shown in FIG. 6, support surfaces 30, 40, 52 and 53 of holding tabs 17 of electric motor 12, that is not shown, and support surfaces 31 and 51 at the projections of pocket side walls 8 and 8′ of mounting 1 fixed to the frame are shown. Free spaces 36, 37, 42, 55 and 56, described in FIG. 6, are also shown. First elastic element 33 described in the previous figures, ahd second elastic element 54 described in FIG. 6, here form a rectangular ring 60.Pocket side walls 8 and 8′, that run perpendicular to vibrational plane 25, go over into pocket end face 7′. The latter is situated nearly parallel to vibrational plane 25. End face 22 of damping element 21 abuts pocket end face 7′. In this way, damping element 21 is fixed in the plane perpendicular to vibrational plane 25. It is stopped on the opposite at end face 23 of damping element 21, and this is not seen in this illustration. A more accurate description of the manner of stopping it is given in FIG. 1. What is shown are free spaces 36, 37, 42, 55 and 56. In this exemplary embodiment, too, the damping of the rotary vibration takes place by the interplay between the damping of the first half-wave of the vibration, using first elastic element 33 and the damping of the second half-wave of the vibration using second elastic element 54 in an analogous manner to the procedure described in FIG. 6.

Here too, the dimensions are selected in such a way that the position of the free space between holding tabs 17, that is bridged by elastic element 21, is clearly greater than the length of support surfaces 31 or 51, on which elastic element 21 is supported at the projection of pocket side wall 8 or 8′.

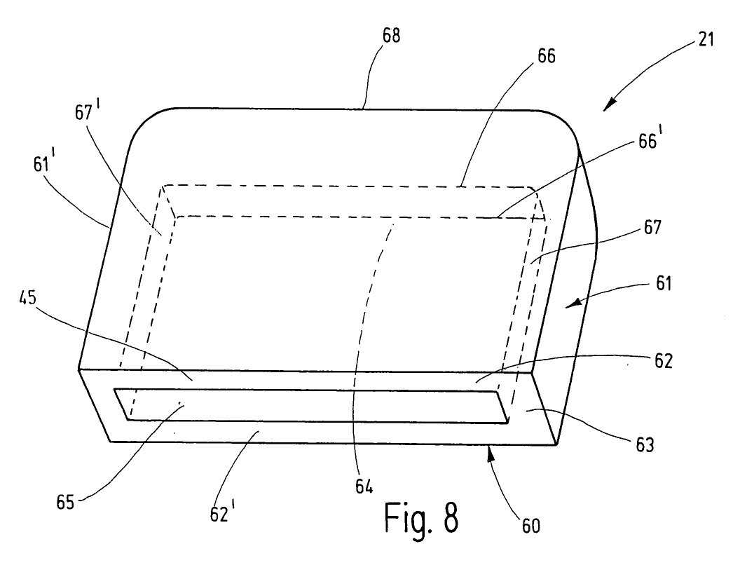

FIG. 8 shows the bonnet-shaped design of damping element 21 in perspective. Rectangular ring 60 explained in FIG. 7, thus, in this case has in each case two side walls 61 and 61′ lying opposite to each other, as well as 62 and 62′, which run essentially perpendicular to the formers' ring-shaped end face 63, and are connected to one another by a floor 68. Side walls 61 and 62 are the side walls facing the viewer, and side walls 61′ and 62′ are shown covered in this illustration. Recess 64, situated in the middle of damping element 21, is developed, starting from free surface 65 in the middle of ring-shaped end face 63 of damping element 21, in each case essentially parallel to side surfaces 61 and 61′ and side surfaces 62 and 62′. Recess 64 has side walls 66 and 66′, facing each other, as well as side walls 67 and 67′, also facing each other. Both are shown covered in the perspective illustration, and are therefore shown by broken lines. Side walls 67 and 67′, in this context, run essentially parallel to outer side walls 61 and 61′ of damping element 21, and side walls 66 and 66′ run essentially parallel to side walls 62 and 62′.

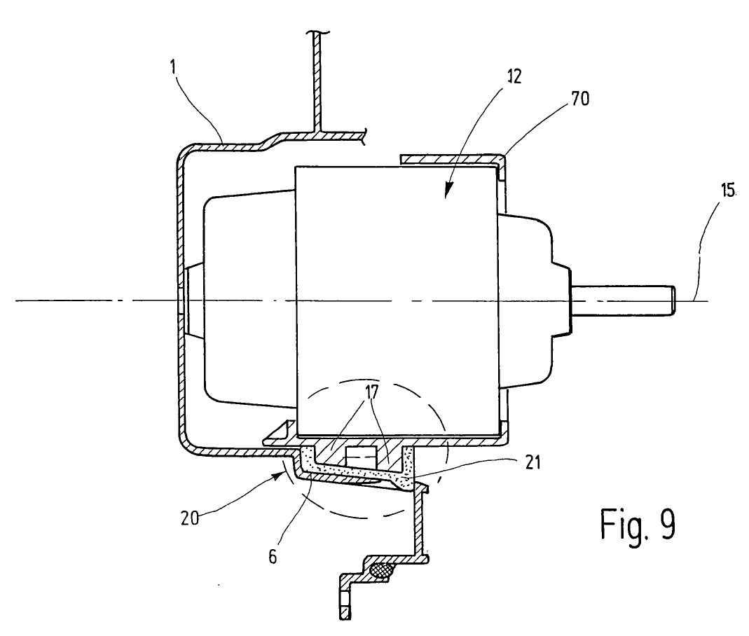

FIG. 9 shows an exemplary embodiment having an adapter 70, which partially encloses electric motor 12.

Holding tabs 17, which are formed as one piece with electric motor 12 in the exemplary embodiment shown in FIG. 1, start in this exemplary embodiment from adapter 70, and are preferably developed in one piece with it. The design of device 20 for the rotary vibration-damping accommodation of electric motor 12 in adapter 70, and its functioning, are identical to those in the exemplary embodiment shown in FIG. 1. For this reason, we refer here to the description related to FIG. 1.

For all the exemplary embodiments described of a rotary vibration-damping accommodation of an electric motor 12 in a mounting 1 that is fixed to a frame, it is true that the width of the support surfaces has, in each case, to be substantially smaller than the respective lateral clearance between the two support surfaces, in order to guarantee the functioning of the free bridges.

A device for accommodating an assembly 19, such as an electric motor 12 in a mounting fixed to a frame, may also gave more support surfaces than the number of support surfaces of the exemplary embodiments shown in FIGS. 3 through 8. The specific embodiment of the arrangement of the support surfaces, both at mounting 1 fixed to the frame and at assembly 19, depends on the structural designs, on the one hand of assembly 19, and on the other hand of mounting 1 fixed in the frame. By structural designs we mean, in particular, their size. If, for example, the motor is very large and/or heavy, it may be advantageous to increase the number of holding tabs, and thereby the support surfaces at the motor, in order to achieve a stable rotary vibration-damping accommodation. At the same time, the mounting fixed in the frame must then also have more support surfaces. The number of support surfaces is not what is decisive for the damping, but rather only the fact that the sequence of the support surfaces, namely support surface assembly, support surface mounting fixed to the frame, support surface assembly etc, and the lateral clearance between two support surfaces of the same component and the support surface of the other component that faces these support surfaces is maintained. In this context, the support surfaces of assembly 19 and the support surfaces of mounting 1 fixed to the frame have to be in each case facing each other, and an elastic element has to be situated in an overlapping position between the support surfaces of assembly 19 mounting 1 fixed to the frame. Besides, for the damping properties, the material of the damping element and of the elastic element, as well as the thickness of the material lying between the support surfaces are decisive.

1-16. (canceled)

17. A device for an elastic, vibration-damping accommodation of an assembly with respect to a mounting fixed to a frame, comprising:
at least one first elastic element situated between the assembly and the mounting, wherein:
the assembly includes at least one first support surface,
the mounting includes at least one second support surface,
the at least one first support surface and the at least one second support surface face each other and run transversely at right angles to a vibrational plane of a vibration,
as seen in a direction of the vibration, the at least one first elastic element lies in an overlapping position to the at least one first support surface and the at least one second support surface,
the at least one first support surface and the at least one second support surface have a lateral clearance from each other, and
the at least one first elastic element bridges the lateral clearance in the form of a first free bridge.

18. The device as recited in claim 17, wherein:
the assembly includes at least one third support surface situated at a second lateral clearance from the at least one first support surface and at a third lateral clearance from the at least one second support surface,
the third lateral clearance faces the at least one second support surface and runs transversely at right angles to the vibrational plane,
the at least one second support surface lies between the at least one first support surface and the at least one third support surface, as seen in the direction of the vibrational plane,
the at least one first elastic element, as seen in the vibrational direction, lies in an overlapping position to the at least one second support surface and to the at least one third support surface, and
the at least one first elastic element bridges a lateral clearance between the at least one second support surface and the at least one third support surface in the form of a second free bridge.

19. The device as recited in claim 17, wherein:
the mounting includes at least one third support surface, situated at a second lateral clearance from the at least one second support surface and at a third lateral clearance from the at least one first support surface,
the at least one third support surface faces the at least one first support surface and runs transversely at right angles to the vibrational plane of the vibration,
the at least one first support surface lies between the at least one second support surface and the at least one third support surface, as seen in the direction of the vibrational plane of the vibration,
the at least one first elastic element lies in an overlapping position to the at least one first support surface and to the at least one third support surface, as seen in the vibrational direction, and
the at least one first elastic element bridges the second lateral clearance in the form of a second free bridge.

20. The device as recited in claim 17, wherein:
the mounting includes a third support surface that faces the second support surface,
the assembly includes a fourth support surface and a fifth support surface that have a lateral clearance from each other and that face the third support surface,
the third support surface lies between the fourth and fifth support surfaces, as seen in the vibrational plane,
a second elastic element lies in an overlapping position to the third, fourth, and fifth support surfaces, as seen in the vibrational direction, and
the second elastic element bridges the lateral clearance between the third and fourth support surfaces in the form of a second free bridge, and bridges the lateral clearance between the third and the fifth support surfaces in the form of a third free bridge.

21. The device as recited in claim 1, wherein:
the assembly includes a third support surface that faces the first support surface,
the mounting includes a fourth and a fifth support surfaces that have a lateral clearance from each other and that face the third support surface,
the third support surface lies between the fourth and the fifth support surfaces, as seen in the vibrational plane,
a second elastic element lies in an overlapping position to the third, fourth, and fifth support surface, as seen in the vibrational direction,
the second elastic element bridges the lateral clearance between the third and the fourth support surfaces in the form of a second free bridge, and
the lateral clearance between the third and the fifth support surfaces is in the form of a third free bridge.

22. The device as recited in claim 17, wherein the at least one first elastic element is composed of a plurality of elastic partial elements.

23. The device as recited in claim 17, wherein the at least one first elastic element is developed in one piece with a second elastic element.

24. The device as recited in claim 17, wherein the at least one first elastic element is developed as a ring with a second elastic element.

25. The device as recited in claim 24, wherein the ring is a rectangular ring.

26. The device as recited in claim 17, wherein:
the mounting includes a pocket that has two opposite pocket side surfaces, and
the pocket side surfaces form the at least one first support surface and the at least one second support surface.

27. The device as recited in claim 17, wherein:
the at least one first support surface and the at least one second support surface are formed at an adapter that is detachably connected to the assembly.

28. The device as recited in claim 17, wherein the device is a device for a rotary vibration-damping accommodation of the assembly.

29. The device as recited in claim 17, wherein the assembly is a driving assembly corresponding to an electric motor.

30. The device as recited in claim 17, wherein the assembly is a driven assembly corresponding to a blower drive.

31. The device as recited in claim 30, wherein the driven assembly is an assembly in a motor vehicle.

32. The device as recited in claim 17, wherein the mounting is an assembly mounting of a motor vehicle.
